(19) United States
(12) Patent Application Publication
(10) Pub. No.: US 2010/0009839 A1
(43) Pub. Date: Jan. 14, 2010

(54) Ultrahard Composite Materials

(76) Inventors: Antionette Can, Sunward Park (ZA); Geoffrey John Davies, Randburg (ZA); Anna Emela Mochubele, Benoni (ZA); Johannes Lodewikus Myburgh, Helderkruin (ZA)

Correspondence Address: FROMMER LAWRENCE & HAUG, 745 FIFTH AVENUE- 10TH FL., NEW YORK, NY, 10151, US

(21) Appl. No.: 12/304,029

(22) PCT Filed: Jun. 8, 2007
(86) PCT No.: PCT/IB07/01548

§ 371 Date: Aug. 20, 2009

(30) Foreign Application Priority Data
Jun. 9, 2006 (ZA) 2006/04753

(51) Int. Cl. C04B 35/56; C04B 35/00; C04B 35/58; C04B 35/5831

(52) U.S. Cl. 501/87; 501/96.1; 501/94; 501/96.4

(57) ABSTRACT

The present invention concerns a method of producing an ultrahard abrasive composite material having a desirable overall thermal expansion coefficient mismatch, between the ultrahard particles and their matrix materials. The method includes the steps of providing a volume fraction of ultrahard particles having a pre-determined thermal expansion coefficient; determining the volume fraction and thermal expansion coefficient of a matrix material that would be required to produce an ultrahard composite material having a desired overall thermal expansion coefficient mismatch; contacting the ultrahard particles and the matrix material to form a reaction volume; and consolidating and sintering the reaction volume at a pressure and a temperature at which the ultrahard particles are crystallographically or thermodynamically stable. Ultrahard composites where the ultrahard particles are cubic boron nitride and/or diamond are provided, with matrix materials chosen to produce thermal expansion mismatches within specific value ranges, and associated, controlled residual stresses. Ultrahard composite matrices involving combinations of nitride matrices such as titanium nitride/tantalum nitride, and titanium nitride/chromium nitride are exemplified.

### BACKGROUND OF THE INVENTION

THIS invention relates to ultrahard composite materials, and to methods of making them.

Ultrahard composite materials, typically in the form of abrasive compacts, are used extensively in cutting, milling, grinding, drilling and other abrasive operations. They generally contain ultrahard abrasive particles dispersed in a second phase matrix. The matrix may be metallic or ceramic or a cermet. The ultrahard abrasive particles may be diamond, cubic boron nitride (cBN), silicon carbide or silicon nitride and the like. These particles may be bonded to each other during the high pressure and high temperature compact manufacturing process generally used, forming a polycrystalline mass, or may be bonded via the matrix of second phase material(s) to form a polycrystalline mass. Such bodies are generally known as polycrystalline diamond (PCD), or polycrystalline cubic boron nitride (PCBN), where they contain diamond or cBN as the ultrahard particles, respectively.

PCT application WO2006/032984 discloses a method of manufacturing a polycrystalline abrasive element, which includes the steps of providing a plurality of ultrahard abrasive particles having vitreophilic surfaces, coating the ultrahard abrasive particles with a matrix precursor material, treating the coated ultrahard abrasive particles to render them suitable for sintering, preferably to convert the matrix precursor material to an oxide, nitride, carbide, oxynitride, oxycarbide, or carbonitride of the matrix precursor material, or an elemental form of the matrix precursor material, or combinations thereof, and consolidating and sintering the coated ultrahard abrasive particles at a pressure and temperature at which they are crystallographically or thermodynamically stable. In this way ultrahard polycrystalline composite materials are made having ultrahard particles homogeneously dispersed in fine, sub-micron and nano grained matrix materials.

The ultrahard abrasive elements typically comprise a mass of ultrahard particulate materials of any size or size distribution smaller than about several hundred microns, down to and including sub-micron and also nano-sizes (particles less than 0.1 microns i.e. 100 nm), which are well dispersed in a continuous matrix made of extremely fine grained oxide ceramics, non-oxide ceramics, cermets or combinations of these classes of materials.

EP 0 698 447 discloses another approach to the generation of ultrahard composite materials, whereby the matrix is generated by the pyrolysis of organometallic polymer precursors, such as pyrolysis of polymerized polysilazanes. This has particular utility for the generation of ultrahard composites derived from diamond and/or cBN where the ceramic matrices are selected from silicon carbide, silicon nitride, silicon carboniuride, silicon dioxide, boron carbide, aluminium nitride, tungsten carbide, titanium nitride, and titanium carbide.

It is desirable for the ultrahard composites to be optimizeable in regard to their mechanical properties and their performance in applications. In particular superior performance is desired in wear related applications such as machining of hard to machine materials and rock drilling. A potential problem in such ultrahard composites, however, is the effect of the thermal expansion coefficient mismatches between the ultrahard particles and the matrix material on overall performance.

### SUMMARY OF THE INVENTION

According to one aspect of the invention, a method of producing an ultrahard abrasive composite material having a desirable overall thermal expansion coefficient mismatch, includes the steps of:
(a) providing a volume fraction of ultrahard particles having a pre-determined thermal expansion coefficient;
(b) determining the volume fraction and thermal expansion coefficient of a matrix material that would be required to produce an ultrahard composite material having a desired overall thermal expansion coefficient mismatch;
(c) selecting a matrix material having the determined thermal expansion coefficient in the determined volume fraction;
(d) contacting the ultrahard particles of (a) and the matrix material of (c) to form a reaction volume; and
(e) consolidating and sintering the reaction volume at a pressure and a temperature at which the ultrahard particles are crystallographically or thermodynamically stable.

According to another aspect of the invention, an ultrahard composite material having a desired overall thermal expansion coefficient mismatch comprises ultrahard particles dispersed in a matrix, in particular a nano-grain sized matrix, the relative thermal expansion coefficients and volume fractions of the ultrahard particles and matrix being such as to provide the desired overall thermal expansion coefficient mismatch of the ultrahard composite material.

The overall thermal expansion coefficient mismatch may be classified as a large thermal expansion coefficient mismatch, considered to be in the range of about 7×10⁻⁶ K⁻¹ to about 10×10⁻⁶ K⁻¹, an intermediate thermal expansion coefficient mismatch, considered to be in the range of about 4×10⁻⁶ K⁻¹ to about 7×10⁻⁶ K⁻¹, or a small thermal expansion coefficient mismatch, considered to be in the range of about 0.1×10⁻⁶ K⁻¹ to about 4×10⁻⁶ K⁻¹, preferably 1.0×10⁻⁶ K⁻¹ to 4×10⁻⁶ K⁻¹, more preferably about 1.5×10⁻⁶ K⁻¹ to 4×10⁻⁶ K⁻¹.

The matrix material is preferably selected from the group consisting of the oxides, nitrides, carbides, oxynitrides, oxycarbides and carbonitrides of aluminium, titanium, silicon, vanadium, zirconium, niobium, hafnium, tantalum, chromium, molybdenum and tungsten and any appropriate combination of these materials.

Preferably, the ultrahard composite material of the invention comprises diamond and/or cBN particles, preferably micron or sub-micron diamond and/or cBN particles, dispersed in a nano-grain sized matrix comprising chromium nitride (CrN and/or Cr₂N), titanium nitride (TIN), tantalum nitride (TaN and/or Ta₃N₅), niobium nitride (NbN), vanadium nitride (VN), zirconium nitride (ZrN), hafnium nitride (HfN), titanium carbide (TiC), tantalum carbide (TaC and/or Ta₂C), niobium carbide (NbC), vanadium carbide (VC), zirconium carbide (ZrC), hafnium carbide (HfC), or combinations thereof.

Preferred ultrahard composite materials include those wherein the matrix of the composite material so produced comprises a single phase solid solution of general formula M′ₓM″₁₋ₓN, wherein x is in the range 0.1 to 0.9, and M′ and M″ are any two metal elements selected from Ti, Ta, V, Nb, Zr, Cr, W and Mo. Examples are Ti_{X}Ta_{1-X}N and Ti_{X}Cr_{1-X}N, wherein X is in the range 0.1 to 0.9.

Another preferred composite material is one wherein the matrix is a chromium nitride phase having the formula Cr₂N.

### DETAILED DESCRIPTION OF PREFERRED EMBODIMENTS

The ultrahard composite materials, typically formed as polycrystalline abrasive bodies, also referred to as polycrystalline abrasive elements, are used as cutting tools for turning, milling and honing, drilling cutters for rock, ceramics and metals, wear parts and the like. The invention is particularly directed to tailoring the thermal expansion coefficient mismatches of the composite materials where the material phases present are micron, sub-micron and/or nano-grain sized, so that the expected improvements in properties and behaviour in applications as a result of the use of such material phases can be exploited.

The invention takes advantage of the methods of manufacturing ultrahard abrasive composite materials disclosed in PCT application WO2006/032984 and EP 0 698 447, which are optimised in accordance with the present invention, and which are incorporated herein by reference.

In particular the thermal expansion coefficient mismatch between the ultra hard particles and the matrix materials, and preferably also the grain size of the matrix, are tailored to produce the ultra hard abrasive composites of the invention.

The ultrahard composite materials may be generated by the sintering of the matrix material at high temperature and pressure. At these conditions both particles and matrix reach elastic, plastic equilibrium with each other after sintering and thus there will be an absence of local stress, provided the high temperature and pressure conditions are maintained.

On cooling to room temperature, however, differences in thermal expansion coefficient between the ultrahard particles and the matrix will generate local stresses at the scale of the particle, matrix microstructure.

It is known in the literature that the thermal expansion mismatch stress, τ_{T} inside a single spherical particle in an infinite matrix may be expressed by the Selsing formula, (J. Selsing; “Internal Sresses in Ceramics”; J. Am. Ceram. Soc., 1961, vol. 44, p 419):

σ_{T}=ΔαΔT/T (1)

where Δα=αₚ−αₘ (2)

which is the difference in thermal expansion coefficient between the particle, αₚ and the matrix, αₘ;

where ΔT=Tₚₗ−Tᵣₒₒₘ (3)

which is the difference between the elastic, plastic transition temperature of the matrix, Tₚₗ and room temperature, Tᵣₒₒₘ; and

where Γ=(1+υₘ)/2Eₘ+(1−2υp)/Ep (4)

where υ is Poisson's ratio, E is Young's modulus, and the subscripts m and p denote matrix and particle, respectively.

The tangential, σ_{Tt}, and radial, σ_{Tr}, stress distributions in the matrix around the particle may be given by:

σ_{Tt}=−(σ_{T}/2)(rₚ/x)³ (5)

and σ_{Tr}=σ_{T}(rₚx)³ (6)

where rₚ denotes the radius of the particle and x is the radial distance from the particle.

In the case where αₘ axis greater than αₚ, the average thermal stresses are compressive in the particles and tensile in the matrix, as illustrated in the accompanying schematic diagram, FIG. 1.

The Selsing model, formulae (1) through to (6), indicates that the local internal stresses in a composite material, made up of particles distributed in a continuous matrix, should be dependent upon the sense and magnitude of thermal expansion coefficient difference between the particles and the matrix. The larger the thermal expansion difference the larger the expected stress distributions at the scale of the hard particle, matrix microstructure. It is expected therefore that the mechanical properties and mechanisms of fracture of a composite material can thus be significantly affected by, and dependent upon the relative thermal expansion coefficients of the hard particle material and the continuous matrix material. A particular model of this would be for the case illustrated in the accompanying diagram of FIG. 1 where ultrahard particles of low thermal expansion coefficient are distributed in a continuous nano grain sized matrix of higher thermal expansion coefficient. Note that the ultrahard particles are in compression, as illustrated by the arrows in particle A, and that there are tensile stresses in the matrix around each particle, \hat{9}_{Tens}. The compressive stress on the particles should theoretically inhibit crack transmission through the particles. The tensile stresses at or close to the interface of the particles with the matrix should, however, attract the passage of cracks. This model therefore indicates that a dominant fracture mode for composites of this type may well be fracture in the matrix, following a path around the ultrahard particles, i.e intergranular fracture. Deflection of cracks around the hard particles may well be regarded as a toughening mechanism.

Many of the ultrahard composite materials disclosed and/or claimed in PCT application WO2006/032984 and EP 0 698 447, have nitrides and carbides and combinations of the same, as the chosen matrix materials. In turn many of these nitrides and carbides take up the well known B1, sodium chloride cubic structure. The ceramics of this structure are known to have very large and in some cases complete ranges of solid solubility with each other. In solid solutions of these materials, the cations are considered to be interchangeable and similarly carbon and nitrogen are interchangeable over very large composition ranges. Oxygen may also replace nitrogen or carbon in such solid solutions.

The thermal expansion coefficient of such solid solutions may be given by:

αₛ=V₁α₁+V₂α₂ (7)

where αₛ is the thermal expansion coefficient of the combination of materials, α₁ and α₂ are the thermal expansion coefficients of constituent materials 1 and 2, respectively, and V₁ and V₂ are the volume fractions of materials 1 and 2, respectively.

Equation (7) also applies if two solid materials are combined to full density and well mixed, without reactions having occurred, giving rise to a third or fourth material. Equation (7) arises because thermal expansion coefficients for intimately mixed, fully dense, multi-component materials obey the classical law of mixtures.

A generalized equation from equation (7) may be written:

υₛ=V₁α₁+V₁₊ₓα₁₊ₓ (8)

where x can be any number from 1 or greater and

V=V₁+V_{1+X} (9)

When considering ultrahard composite materials in the current application an equation for the overall thermal expansion coefficient for the composite may be written:

υ_{c}=Vₚαₚ+Vₘαₘ (10)

where υ_{c} is the thermal expansion coefficient of the overall composite material, αₚ and αₘ are the expansion coefficients of the ultrahard particle and matrix materials, respectively, and Vₚ and Vₘ are the volume fractions of the ultrahard particles and matrix material which make up the overall composite, respectively.

The law of mixtures as applied to thermal expansion coefficients, and expressed in equations (7), (8) (9) and (10), implies that the thermal expansion coefficient of a material which can be made by combination of two or more separate components may be chosen and determined by knowledge of the thermal expansion coefficient of each component and the volume fraction of each component.

In particular, in this way, by combination of chosen matrix materials, the thermal expansion coefficient of the overall matrix material can be manipulated such that the thermal expansion mismatch between the overall matrix and the ultrahard particle component of the composite is chosen.

It may be desired to maximize or minimize the thermal expansion difference and hence the corresponding expansion mismatch and resultant stresses.

Lowering the thermal expansion coefficient difference, resulting in a lowering of the thermal expansion coefficient mismatch between the ultrahard particles and the matrix, are believed to improve the mechanical behavior of the composite due to a reduction in the residual tensile stresses in the matrix.

Increasing the thermal expansion coefficient difference, resulting in an increase of the thermal expansion coefficient mismatch between the ultra hard particles and the matrix, under certain circumstances, are also believed to improve the mechanical behavior of the composite. An example of such circumstance is where controlled micro cracking and/or crack deflection can occur in the matrix, providing a toughening mechanism for the composite material.

Generally, it is desirable to be able to manipulate and choose the thermal expansion coefficient mismatch between the ultrahard particles and the matrix in composite materials and so be determinant in regard to the stress situation at the scale of the particle microstructure.

The applicant has found that the thermal expansion coefficient of the matrix component of a composite may be estimated from a measurement of the thermal expansion coefficient of the overall composite and knowledge of the expansion coefficient and volume fraction composition of ultrahard component material, by use of equation (10) above. The difference in thermal expansion coefficient can thus be estimated in each case.

Accordingly, the present invention provides a method of producing ultrahard composite materials, where the thermal mismatch tensile stresses in the matrix are tailored and deliberately chosen in magnitude to be large or small, by virtue of choice of matrix material. Ultrahard composites may be categorized as indicated by the Selsing formulae, equations (1) to (6), on the basis of the magnitude of thermal expansion coefficient difference between the ultrahard particles and matrix material.

For the purposes of this application, large differences in thermal expansion coefficient are considered to be in the range of about 7×10⁻⁶ K⁻¹ to about 10×10⁻⁶ K⁻¹, intermediate differences in the range of about 4×10⁻⁶ K⁻¹ to about 7×10⁻⁶ K⁻¹ and small differences in the range of about 0.1×10⁻⁶ K⁻¹ to about 4×10⁻⁶ K⁻¹, typically about 1.0×10⁻⁶ K⁻¹ to 4×10⁻⁶ K⁻¹, particularly 1.5×10⁻⁶ K⁻¹ to 4×10⁻⁶ K⁻¹. Thermal mismatch stresses in composite materials based upon diamond and cBN in matrix materials where the expansion differences with diamond or cBN fall within these ranges are considered to be large, intermediate and small, respectively. It has been found that the residual stresses in the composite material relate to the thermal expansion mismatch categories.

The thermal expansion coefficient of diamond increases from close to 0.5×10⁻⁶ K⁻¹ at room temperature to about 5×10⁻⁶ K⁻¹ at 1000° C. and that of cBN over the same temperature range from about 1×10⁻⁶ K⁻¹ to 6×10⁻⁶ K⁻¹. These values are published by H. Conrad et al., in International Journal of Refractory Metals and Hard Materials, 23, p 301-305, 2005. At room temperature these are extremely small expansion coefficients.

The matrix materials may typically include the oxides, nitrides, carbides, oxynitrides, oxycarbides and carbonitrides of aluminium, titanium, silicon, vanadium, zirconium, niobium, hafnium, tantalum, chromium, molybdenum and tungsten and any appropriate combination of these materials. The room temperature thermal expansion coefficients of these materials fall between about 2×10⁻⁶ K⁻¹ and about 10×10⁻⁶ K⁻¹, and mostly between about 4×10⁻⁶ K⁻¹ and about 10×10⁻⁶ K⁻¹.

Table 1 provides an exemplary list of matrix materials with their published room temperature thermal expansion coefficients. Table 1 also shows the magnitude of the expected difference between these materials, as matrices, and diamond and cBN.

The typical stresses when using these materials as matrices for diamond and/or cBN are therefore, as indicated by equations (1) through (6), that the ultrahard particles will be in compression and the matrices in various degrees of tensile stress dependent upon the magnitude of their thermal expansion coefficients. The various ultrahard composite materials can thus be ranked and chosen in regard to the expected thermal expansion coefficient differences for each type of ultrahard particle. Table 1 lists in order of magnitude the room temperature coefficient of thermal expansion of some of the matrix materials covered in PCT application WO2006/032984 and EP 0 698 447, which is also the same order of expected coefficient of thermal difference with ultrahard particles such as diamond and cBN. The thermal expansion values listed in Table 1 are taken from the Handbook of Ceramic Hard Materials, Ed. Ralf Riedel, Vol 1, Table 1, p. 968, pub. Wiley-VCH, 2000. and H. Conrad et al., International Journal of Refractory Metals and Hard Materials, 23, p 301-305, 2005.

TABLE 1

| | Thermal | | | | |
|---|---|---|---|---|---|
| | Expansion | | m (matrix) | −α cf. | −α cf. |
| | Coefficient | Ceramic | p (hard | Diamond | cBN |
| Material | α (10⁻⁶ K⁻¹) | class | particle) | (10⁻⁶ K⁻¹) | (10⁻⁶ K⁻¹) |
| Cr₃C₂ | 10.3 | Carbide | m | 9.8 | 9.3 |
| NbN | 10.1 | B1 nitride | m | 9.6 | 9.1 |
| ZrO₂ | 10.0 | Oxide | m | 9.5 | 9.0 |
| TiN | 9.4 | B1 nitride | m | 8.9 | 8.4 |
| Cr₂N | 9.4 | Nitride | m | 8.9 | 8.4 |
| Al₂O₃ | 8.3 | Oxide | m | 7.8 | 7.3 |
| VN | 8.1 | B1 nitride | m | 7.6 | 7.1 |
| Mo₂C | 7.8 | Carbide | m | 7.3 | 6.8 |
| TiC | 7.4 | B1 carbide | m | 6.9 | 6.4 |
| VC | 7.3 | B1 carbide | m | 6.8 | 6.3 |
| ZrN | 7.2 | B1 nitride | m | 6.7 | 6.2 |
| NbC | 7.2 | B1 carbide | m | 6.7 | 6.2 |
| HfN | 6.9 | B1 nitride | m | 6.4 | 5.9 |
| HfC | 6.9 | B1 carbide | m | 6.4 | 5.9 |
| ZrC | 6.7 | B1 carbide | m | 6.2 | 5.7 |
| TaC | 6.3 | B1 carbide | m | 5.8 | 5.3 |
| WC | 6.0 | Carbide | m & p | 5.5 | 5.0 |
| AIN | 5.7 | Nitride | m | 5.2 | 4.7 |
| B₄C | 4.5 | Carbide | p | 4.0 | 3.5 |
| SiC | 4.4 | Carbide | m & p | 3.9 | 3.4 |
| TaN | 3.6 | B1 nitride | m | 3.1 | 2.6 |
| Si₃N₄ | 3.2 | Nitride | m & p | 2.7 | 2.2 |
| CrN | 2.3 | B1 nitride | m | 1.8 | 1.3 |
| cBN | 1.0 | | p | 0.5 | 0 |
| Diamond | 0.5 | | p | 0 | −0.5 |

Another important aspect of the invention is where the ultrahard composite materials have a matrix that is made up of combinations of materials of high and low thermal expansion coefficients so that the resultant thermal expansion coefficient of the matrix is significantly lowered from that of the highest thermal expansion component and so the expansion difference and consequent thermal mismatch stresses with the ultrahard particle component is lowered. In this way other desirable properties of high thermal expansion coefficient materials can be exploited without suffering the potential undesirable consequences of large thermal mismatch stresses.

An alternative is to provide ultrahard composite materials whereby the matrix is made up of combinations of materials of high and low thermal expansion coefficients so that the resultant thermal expansion coefficient of the matrix is significantly increased from that of the lowest thermal expansion component and in this way the expansion difference and consequent thermal mismatch stresses with the ultrahard particle component is increased. In this way desirable properties of high thermal expansion coefficient materials can be exploited which depend upon large thermal mismatch stresses. A possible example of this is where sufficient local tensile stresses are present for micro-crack based toughening mechanisms to be operative.

A particular embodiment of PCT application WO2006/032984 is an ultrahard composite material consisting of micron or sub-micron sized cBN particles in a nano grain sized chromium nitride (B1 structure CrN) matrix. It may be noted from Table 1 that CrN has a very low thermal expansion coefficient of close to 2.3×10⁻⁶ K⁻¹ and thus the thermal expansion difference between cBN as an ultrahard particle and CrN as a matrix material, at 1.3×10⁻⁶ K⁻¹, is very small. It would thus be expected that particularly small thermal expansion mismatch stresses would occur in this type of material. A composite of this general composition would thus be considered as belonging to the low thermal expansion mismatch category. It may be noted from Table 1 that B1 cubic CrN has a room temperature coefficient of expansion lower than all the other exemplary matrix materials. Ultrahard composites exploiting CrN as their sole matrix material should thus have the smallest thermal mismatch stresses in each case. These ultrahard composites are thus preferred when composite materials with the lowest expansion mismatch are desired and clearly fall within the low thermal mismatch category.

Another embodiment of PCT application WO2006/032984, is an ultrahard composite material consisting of micron or sub-micron sized cBN particles in a nano grain sized titanium nitride (TiN) matrix. It may be noted from Table 1 that TiN has a large thermal expansion coefficient of about 9.4×10⁻⁶ K⁻¹, and thus the thermal expansion difference between cBN as an ultrahard particle and TiN as a matrix material, at 8.4×10⁻⁶ K⁻¹, is very large. It would thus be expected that large thermal expansion mismatch stresses would occur in this type of material. A composite of this general composition would thus be considered as belonging to the high thermal expansion mismatch category.

Another chromium nitride matrix embodiment is one which includes another phase of chromium nitride, namely the hexagonal Cr₂N phase. By choice of method and conditions, it is possible to generate this phase instead of the B1 CrN phase. However, in this case, as can be seen from Table 1, the expansion coefficient of Cr₂N is much larger than that of the B1 structure CrN, and is close to that of B1 structure titanium nitride (TiN), specifically 9.4×10⁻⁶ K⁻¹. Thus, an ultrahard composite made from diamond or cBN utilizing the Cr₂N phase of chromium nitride will have a thermal expansion coefficient mismatch of about 8.4×10⁻⁶ K⁻¹ to 8.9×10⁻⁶ K⁻¹. A composite of this general composition would thus also be considered as belonging to the high thermal expansion mismatch category.

CrN and TiN both occur in the B1 sodium chloride cubic system. They thus are able to form an extensive range of solid solubility. Thus it is possible by combining these nitrides from close to 100 vol % CrN to close to 100 vol % TiN to vary the coefficient of thermal expansion of such a combined matrix material anywhere between close to 2.3×10⁻⁶ K⁻¹ to close to 9.4×10⁻⁶ K⁻¹. In this way the room temperature thermal expansion mismatch in a cBN based composite of such nature may be varied from about 1.3×10⁻⁶ K⁻¹ to about 8.4×10⁻⁶ K⁻¹. Table 2 is an exemplary list of some preferred composite materials where the matrices are chosen binary combinations of CrN and TiN, with chosen thermal expansion mismatches.

TABLE 2
Titanium Nitride, Chromium Nitride Binary Matrices

| | | Expected matrix | Expected expansion |
|---|---|---|---|
| | | expansion | coefficient |
| Ultrahard | Mixed matrix | coefficient, | difference, |
| component | (vol %) | (10⁻⁶K⁻¹) | (10⁻⁶K⁻¹) |
| cBN | 80TiN/20 CrN | 7.98 | 6.98 |
| cBN | 50TiN/50 CrN | 5.85 | 4.85 |
| cBN | 20TiN/80 CrN | 3.72 | 2.72 |
| Diamond | 80TiN/20 CrN | 7.98 | 7.48 |
| Diamond | 50TiN/50 CrN | 5.85 | 5.35 |
| Diamond | 20TiN/80 CrN | 3.72 | 3.22 |

It may be seen from Table 2 that, both for cBN and diamond as the ultrahard component, composites with a matrix of 80 vol % TiN and 20 vol % CrN fall into the high thermal mismatch category, composites with a matrix of 50 vol % TiN and 50 vol % CrN fall into the intermediate thermal mismatch category and composites with a matrix of 20 vol % TiN and 80 vol % CrN fall into the low thermal mismatch category. These are preferred embodiments. By choice of a multicomponent matrix, therefore, the thermal expansion mismatch may thus be designed and tailored.

Tantalum nitride, TaN, is another matrix material with a low thermal expansion coefficient of about 3.6×10⁻⁶ K⁻¹. TaN can occur in the B1 cubic structure and can thus be readily combined with TiN in an extensive range of compositions. Ultrahard composites utilizing TaN as matrix material would thus be desirable, particularly as TaN has a high hardness of about 32 GPa. Ultrahard composites with matrices made up of binary combinations of TiN and TaN will allow matrices where the thermal expansion mismatch may be designed and chosen to be of high, intermediate or low, dependent upon the TaN content of the matrix. Table 3 provides some preferred examples of such ultrahard composite materials, which fall into the high, intermediate and low thermal mismatch categories where either cBN or diamond is the ultrahard component of choice.

TABLE 3
Titanium Nitride, Tantalum Nitride Binary Matrices.

| | | Expected matrix | Expected expansion |
|---|---|---|---|
| | | expansion | coefficient |
| Ultrahard | Mixed matrix | coefficient, | difference, |
| component | (vol %) | (10⁻⁶K⁻¹) | (10⁻⁶K⁻¹) |
| cBN | 80TiN/20 TaN | 8.24 | 7.24 |
| cBN | 50TiN/50 TaN | 6.50 | 5.50 |
| cBN | 20TiN/80 TaN | 4.76 | 3.76 |
| Diamond | 80TiN/20 TaN | 8.24 | 7.74 |
| Diamond | 50TiN/50 TaN | 6.50 | 6.00 |
| Diamond | 20TiN/80 TaN | 4.76 | 4.16 |

In general, choice of the composition of multiple component matrices for the ultrahard particles allows a wide range of potential properties for the composite materials to be designed and tailored.

Another known B1 structure, nitride which is taught in PCT application WO2006/032984 to be a candidate for nano grain sized matrix material for ultrahard composites is niobium nitride, NbN. NbN has a thermal expansion coefficient of close to 10.1×10⁻⁶ K⁻¹, which as may be seen from Table 1, is greater than that of TiN (about 9.4×10⁻⁶ K⁻¹). A binary combination of TiN and NbN thus allows matrices with thermal expansion coefficients greater than that of TiN alone to be created. Preferred examples of ultrahard composites of such matrices would be cBN or diamond in a matrix made up of at least 50% by volume of NbN and the remainder of TiN. The expected thermal expansion coefficient of such matrices would be expected to be in the range from 9.4×10⁻⁶ K⁻¹ up to and approaching 10.1×10⁻⁶ K⁻¹, with expected thermal expansion mismatches of from about 8.4×10⁻⁶ K⁻¹ to about 9.1×10⁻⁶ K⁻¹ and about 8.9×10⁻⁶ K⁻¹ to about 9.6×10⁻⁶ K⁻¹ for cBN and diamond based composites, respectively. These composites are preferred composites in the very high thermal mismatch category.

An exemplary list of B1 cubic structure nitrides, which may be combined to form ultrahard composite matrices whereby the thermal expansion coefficient of the matrices can be chosen and manipulated by virtue of choice of multiple composition, include NbN, TiN, VN, ZrN, HfN, TaN and CrN. Other properties of such matrices such as hardness, oxidation resistance, thermal and electrical conductivities can also be chosen and manipulated by such combinations. Where Identical or similar thermal expansion coefficients can be generated by different combinations and compositions, differences in these other properties may be determined and created.

Many of the transition metal carbides listed in Table 1 are also able to take up the B1 cubic structure. They can also be combined in very large ranges of composition. These carbides include, in order of increasing thermal expansion coefficient, TaC, ZrC, HfC, NbC, VC and TiC.

A preferred binary combination from this list is TaC and TiC. A preferred composition for such a binary matrix is 50 vol % TaC and 50 vol % TiC. This matrix is expected to have a thermal expansion coefficient of about 6.85×10⁻⁶ K⁻¹ and thermal expansion mismatches with cBN and diamond of about 5.85×10⁻⁶ K⁻¹ and 6.35×10⁻⁶ K⁻¹, respectively. These ultrahard composites would fall within the intermediate thermal mismatch category.

Most of the B1 cubic structure transition metal carbides and nitrides can be combined in wide ranges of compositions to form matrices for ultrahard composites as taught in PCT application WO2006/032984. In this way the thermal expansion mismatch between the matrices and ultrahard components may also be chosen and manipulated.

Although desirable, it is not necessary for the potential matrix material components to be of the same structure in order for them to be advantageously combined. All of the matrix materials listed and exemplified in Table 1 may be combined to generate matrices with thermal expansion coefficients anywhere in the range of about 0.1×10⁻⁶ K⁻¹ to about 10.3×10⁻⁶ K⁻¹.

A preferred example where the matrix components are not of the same structure is where silicon nitride, Si₃N₄, of thermal expansion coefficient close to 3.2×10⁻⁶ K⁻¹, is combined with TiN of thermal expansion coefficient of about 9.4×10⁻⁶ K⁻¹. An even more preferred example is where such a matrix is made up of 50 vol % Si₃N₄ and 50 vol % TiN, with an expected thermal expansion coefficient of about 6.3×10⁻⁶ K⁻¹. This matrix may be used for both cBN and diamond based ultrahard composites.

The invention will now be exemplified by way of the following non-limiting examples. For convenience the examples have been carried out using cBN as the source of ultrahard particles. It will be well understood that the invention as exemplified applies equally to the use of diamond as the source of ultrahard particles.

### Example 1

cBN with an average particle size of 1.5 micron was coated with Cr(OH)₃. 80 grams of the cBN was dispersed in 2 litres of deionised water using a large horn ultrasonic probe at 30% amplitude for 15 minutes. The suspension was then allowed to cool to room temperature. 181.2 gram of Cr(NO₃)₃. 9H₂O was dissolved in 500 ml deionised water and this was added to the cBN suspension. 23.5 vol % NH₄OH solution was added to the stirred suspension, while pH was measured continuously using a pH meter. The NH₄OH was added until a pH of 9 was achieved. After settling, the Cr(OH)₃ coated cBN was washed with deionised water and ethanol. The dried powder was heat treated in air at 450° C. for 5 hours, using a heating rate of 2° C./min and cooled naturally. This powder was then nitrided in a tube furnace in a flowing path of ammonia, using a flow rate of 50 litres/minute, heated up to 800° C. for 9 hours. X-ray diffraction analysis of this powder confirmed that it consists of cBN and hexagonal Cr₂N phases. This powder was sintered at about 1400° C. and 5.5 GPa for about 20 minutes.

The approximate theoretical composition of this system was 80 vol % cBN and 20 vol % Cr₂N. The linear thermal expansion coefficients of the cBN and Cr₂N are 1.0×10⁻⁶ K⁻¹ and 9.4×10⁻⁶ K⁻¹, respectively. Based on the theoretical composition of the composite, using the rule of mixtures, the expected thermal expansion coefficient of this cBN—Cr₂N composite was 2.68×10⁻⁶K⁻¹. The thermal expansion coefficient of the overall composite was measured using a “NETZSCH DIL 402E” dilatometer. The thermal expansion coefficient was found to be 2.65×10⁻⁶K⁻¹, which is very close to the expected value of 2.68×10⁻⁶K⁻¹.

The agreement between the theoretical and experimental thermal expansion coefficients is consistent with the expansion mismatch between the cBN ultrahard particles and the Cr₂N matrix, being of about 8.4×10⁻⁶K⁻¹, which falls within the high thermal expansion mismatch category.

### Example 2

1.5 micron average particle size cBN was coated with TiO₂ to yield a final coat of 30 vol % TiN. This was done using the method as taught generally in WO2006/032984. Specifically, 100 grams of the cBN was dispersed in 1000 ml of AR ethanol. 297.7 g of Ti(OC₃H₇)₄ was dissolved in 220 ml of dry ethanol. In addition, 7.4 moles of deionised water (131 ml) was dissolved in 220 ml of AR ethanol. The Ti(OC₃H₇)₄ and deionised water was added dropwise to the cBN suspension over 2 hours. The suspension was stirred overnight and then dried in a rotary evaporator at 65° C., followed by additional drying in a vacuum at 75° C. for 24 hours. The titanium hydroxide coated cBN powder was heat treated in air at 450° C. for 5 hours (using a heating rate of 2° C./min). The powder was cooled naturally. The resultant powder was nitrided in a tube furnace in flowing ammonia (50 l/min), using a heating rate of 10° C./min and dwelling at 1000° C. for 5 hours. The resultant TiN coated cBN powder was then sintered under the same conditions as for Example 1.

The thermal expansion coefficient of the sintered material was measured using the same method as described in Example 1. The targeted thermal expansion coefficient of the resultant material at room temperature was estimated to be 3.52×10⁻⁶K⁻¹, which is in good agreement with the measured value of 3.8×10⁻⁶K⁻¹ for this material. This is consistent with the expansion mismatch between the cBN ultrahard particles and the TiN matrix, being of about 8.4×10⁻⁶ K⁻¹, which falls within the high thermal expansion mismatch category.

The residual stress in the cBN grains was determined using the standard sin 2ψtechnique on a Siemens D500 diffractometer using Cr—Kα radiation over a ψ tilt range of ±40°, (in accordance with “M. E. Fitzpatrick, A. T. Fry, P. Holdway, F. A. Kandil, J. Shackleton and L. Suominen:” NPL Good Practice Guide No. 52: Determination of Residual Stresses by X-ray Diffraction—Issue 2. September 2005). All measurements were carried out on the same high angle diffraction peak located at approximately 127° 2-theta. Three repeat measurements were performed on each specimen in random locations and directions. The magnitude of the residual stress was then evaluated with the Bruker stress program using the average sliding gravity peak location method and elastic constants (elastic modulus, E=909 GPa, and Poisson's ratio, υ=0.121 respectively).

The residual compressive stress in the cBN grains in this example was determined to be 898 MPa. This is the highest residual stress out of all the examples presented in this filing, in good correlation with the high thermal expansion mismatch category and large thermal expansion coefficient determined for this material.

### Example 3

It is disclosed in WO2006/032984 that ultrahard composites in mixed nitride ceramic matrices can be made with the general method taught. A mixed nitride of proportions equivalent to 10 vol % titanium nitride, TiN, and 10 vol % chromium nitride, CrN, as matrix for 80 vol % cBN was made using the following specific method.

The mixture of nitride coatings was carried out using the method taught generally in WO2006/032984. Specifically, 148.1 g of Cr(NO₃)₃.9H₂O and 198.4 g of Ti(OC₃H₇)₄ was dissolved in 300 ml of dry ethanol. 10 g of cBN was dispersed in 1000 ml of deionised water and the suspension was stirred. The Cr(NO₃)₃.9H₂O and Ti(OC₃H₇)₄ suspension was added dropwise to the cBN suspension over 2 hours. NH₄OH was then added to the cBN suspension until a pH of 9 was measured using a pH meter. The suspension was then stirred overnight. The coated cBN was washed in deionised water and three times with ethanol, followed by drying in a rotary evaporator, and drying in a vacuum oven at 75° C. for 24 hours.

The dried powder was heat treated in N₂ at 10° C./min up to 450° C., dwelling at 450° C. for 3 hours, followed by natural cooling.

This heat treated powder was then nitrided in pure, dry ammonia, flowing at a rate of about 50 l/min, at 1000° C. for 5 hours, using heating and cooling rates of 10° C./min. The mixed nitride coated cBN was then sintered under conditions of high temperature and pressure, as described in Example 1.

This produced a single phase matrix, as exhibited by X-ray diffraction, consistent with it being a solid solution of CrN and TiN, after sintering under conditions as described in Example 1. The thermal expansion coefficient of the sintered material was measured using the same method as described in Example 1. The expected room temperature thermal expansion coefficient of this material was 1.97×10⁻⁶K⁻¹, and the measured value was 1.86×10⁻⁶K⁻¹. This is consistent with the thermal expansion mismatch being about 4.85×10⁻⁶K⁻¹, which corresponds to the intermediate thermal expansion coefficient category.

The residual stress in the cBN grains was determined as described in Example 2. The residual compressive stress in the cBN grains in this example was determined to be 639 MPa. This is a lower residual stress than that in Example 2, in good correlation with the intermediate thermal expansion mismatch category and lower thermal expansion coefficient determined for this material.

### Example 4

To reduce the residual stress in a material consisting of cBN in a nano-TiN matrix, CrN was added to the matrix to deliberately reduce the residual stress in the material, accompanied by a decrease in overall thermal expansion coefficient. The 70 vol % cBN was coated with an intimate mixture of 20 vol % TiN and 10 vol % CrN using a method as described in Example 3. The 70 vol % cBN/20 vol % TiN/10 vol % CrN powder was sintered under the same conditions as given in Example 1. The thermal expansion coefficient of the sintered material was measured using the same method as described in Example 1. The measured room temperature thermal expansion coefficient (2.93×10⁻⁶K⁻¹) was in good agreement with the calculated value (2.81×10⁻⁶K⁻¹).

This is consistent with a thermal expansion mismatch of about 6.0×10⁻⁶K⁻¹, which falls within the intermediate category of thermal coefficient mismatch. The residual stress in the cBN grains was determined as described in Example 2. The residual compressive stress in the cBN grains in this example was determined to be 839 MPa. This is a slightly lower residual stress than that of the material in Example 2, in good correlation with the high thermal expansion mismatch category and a slightly lower thermal expansion coefficient determined for this material (in comparison with the material in Example 2).

### Example 5

Another example of a cBN—TiN material, which was manipulated to produce a lower residual stress material, was prepared by using TaN as an additive into the matrix. A material prepared, which consisted of 84 vol % cBN, 8 vol % TiN and 8 vol % TaN, was made by the hydrolysis and polycondensation of a combination of titanium (IV) isopropoxide and tantalum (V) ethoxide, as taught generally in WO2006/032984.

The cBN was coated with an intimate mixture of TiN and TaN. This powder was sintered under the same conditions as in Example 1. The thermal expansion coefficient of the sintered material was measured using the same method as described in Example 1. There was very good agreement between the theoretical and measured thermal expansion coefficients, which was 1.88×10⁻⁶ K⁻¹ and 1.80×10⁻⁶K⁻¹, respectively. This corresponds to a thermal expansion mismatch of 5.50×10⁻⁶K⁻¹, which falls in the intermediate thermal expansion mismatch category.

The residual stress in the cBN grains was determined as described in Example 2. The residual compressive stress in the cBN grains in this example was determined to be 705 MPa. This is a lower residual stress than that of the material in Example 2, in good correlation with the intermediate thermal expansion mismatch category and lower thermal expansion coefficient determined for this material, when compared with the material in Example 2.

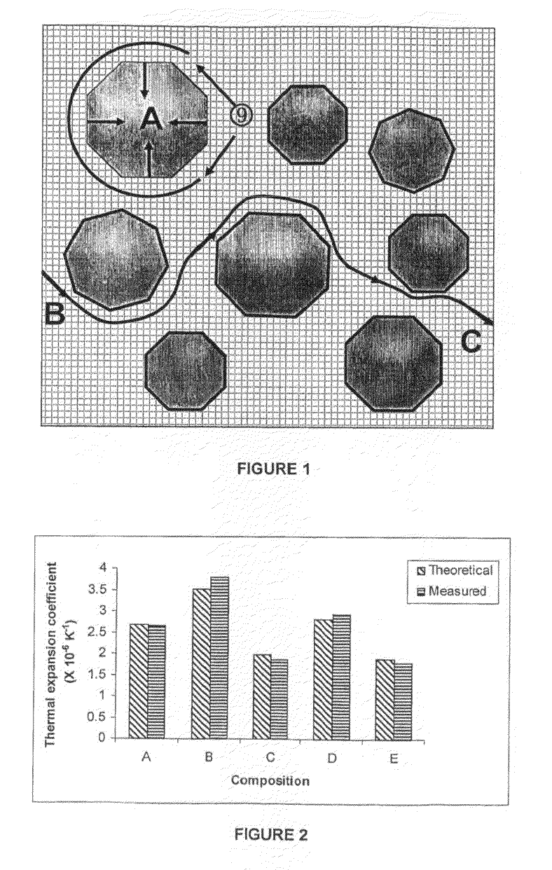

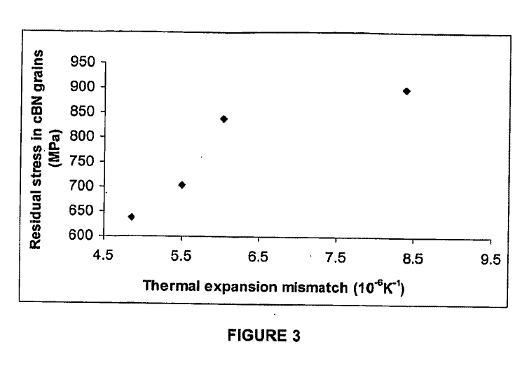

The composition of theoretical versus actual values are summarized in the following table 4 and depicted in the accompanying FIGS. 2 (a plot of the comparison between theoretical and measured thermal expansion coefficients of materials A to E) and 3 (a plot of the mean residual stress in cBN vs thermal expansion mismatch of materials B to E). The residual stress values in the cBN grains for the different materials, listed in Table 4, plotted vs thermal expansion mismatch, depicted in FIG. 3, show that there is a good correlation between measured residual stress in the ultrahard particle and thermal expansion mismatch between the ultrahard particle and matrix.

These results lend credibility to the underlying concepts of the present invention, namely, that residual stresses in these composite materials can be manipulated, by manipulation of thermal expansion mismatches.

TABLE 4

| | | | | | | | Measured |
|---|---|---|---|---|---|---|---|
| | | | Calculated | Measured | | | Mean |
| | | | material | material | Thermal | Thermal | Compressive |
| | | | expansion | expansion | expansion | expansion | Residual |
| | | Composition | coefficient | coefficient | mismatch | mismatch | stress in cBN |
| Ex. | Material | (vol %) | (10⁻⁶ K⁻¹) | (10⁻⁶ K⁻¹ ) | (×10⁻⁶ K⁻¹ ) | category | (MPa) |
| 1 | A | 80cBN/ | 2.68 | 2.65 | 8.4 | High | — |
| | | 20Cr₂N | | | | | |
| 2 | B | 70cBN/30TiN | 3.52 | 3.8 | 8.4 | High | 898 |
| 3 | C | 80cBN/ | 1.97 | 1.86 | 4.85 | Intermediate | 639 |
| | | 10CrN/10TiN | | | | | |
| 4 | D | 70cBN/ | 2.81 | 2.93 | 6.02 | Intermediate | 839 |
| | | 20TiN/10CrN | | | | | |
| 5 | E | 84cBN/8TiN/ | 1.88 | 1.80 | 5.50 | Intermediate | 705 |
| | | 8TaN | | | | | |

1. A method of producing an ultrahard abrasive composite material having a desirable overall thermal expansion coefficient mismatch, includes the steps of:
(a) providing a volume fraction of ultrahard particles having a pre-determined thermal expansion coefficient;
(b) determining the volume fraction and thermal expansion coefficient of a matrix material that would be required to produce an ultrahard composite material having a desired overall thermal expansion coefficient mismatch;
(c) selecting a matrix material having the determined thermal expansion coefficient in the determined volume fraction;
(d) contacting the ultrahard particles of (a) and the matrix material of (c) to form a reaction volume; and
(e) consolidating and sintering the reaction volume at a pressure and a temperature at which the ultrahard particles are crystallographically or thermodynamically stable.

2. A method according to claim 1, wherein the matrix material is selected from the group consisting of the oxides, nitrides, carbides, oxynitrides, oxycarbides and carbonitrides of aluminium, titanium, silicon, vanadium, zirconium, niobium, hafnium, tantalum, chromium, molybdenum and tungsten, and combinations thereof.

3. A method according to claim 1, wherein the matrix material is nano-grain sized and comprises chromium nitride (CrN and/or Cr2N), titanium nitride (TiN), tantalum nitride (TaN and/or Ta3N5), niobium nitride (NbN), vanadium nitride (VN), zirconium nitride (ZrN), hafnium nitride (HfN), titanium carbide (TiC), tantalum carbide (TaC and/or Ta2C), niobium carbide (NbC), vanadium carbide (VC), zirconium carbide (ZrC), or hafnium carbide (HfC), or combinations thereof.

4. A method according to claim 1, wherein the ultrahard composite material comprises diamond and/or cBN particles.

5. A method according to claim 1, wherein the composite material comprises micron or sub-micron diamond and/or cBN particles.

6. A method according to claim 1, wherein the ultrahard particles are contacted with a suspension of the matrix material in order to coat the ultrahard particles, which coated particles are recovered, thereby to form the reaction volume.

7. A method according to claim 1, wherein the matrix of the composite material so produced comprises a single phase solid solution of general formula M′M″1−XN, wherein x is in the range 0.1 to 0.9, and M′ and M″ are any two metal elements selected from Ti, Ta, V, Nb, Zr, Cr, W and Mo.

8. A method according to claim 7, wherein the matrix of the composite material so produced comprises a single phase solid solution of general formula TixTa1−xN, wherein x is in the range 0.1 to 0.9.

9. A method according to claim 7, wherein the matrix of the composite material so produced comprises a single phase solid solution of general formula TixCr1−xN, wherein x is in the range 0.1 to 0.9.

10. A method according to claim 1, wherein the matrix of the composite material so produced is a chromium nitride phase having the formula Cr2N.

11. An ultrahard composite material comprising cBN and/or diamond ultrahard abrasive particles dispersed in a TixTa1−xN solid solution single phase matrix, where x is 0.1 to 0.9.

12. An ultrahard composite material comprising cBN and/or diamond ultrahard abrasive particles dispersed in a TixCri−xN solid solution single phase matrix, where x is 0.1 to 0.9.

13. An ultrahard composite material comprising cBN and/or diamond ultrahard abrasive particles dispersed in a Cr2N matrix.
